(19) United States
(12) Patent Application Publication
(10) Pub. No.: US 2002/0013817 A1
(43) Pub. Date: Jan. 31, 2002

(54) Method and apparatus for distributing of e-mail to multiple recipients

(76) Inventors: Thomas M. Collins, Nazareth, PA (US); Kevin L. Rabinovitch, Hackettstown, NJ (US); Neil A. Willcocks, Flanders, NJ (US); Mark J. Chimel, Long Valley, NJ (US); Henry V. Izzo, Bridgewater, NJ (US); Robert W. Tuttrup, Sparta, NJ (US)

Correspondence Address: FITZPATRICK CELLA HARPER & SCINTO, 30 ROCKEFELLER PLAZA, NEW YORK, NY, 10112, US

(21) Appl. No.: 09/855,584

(22) Filed: May 16, 2001

Related U.S. Application Data
(60) Provisional application No. 60/216,787, filed on Jul. 7, 2000.

(51) Int. Cl. G06F 15/16

(52) U.S. Cl. 709/206; 709/246

(57) ABSTRACT

An apparatus and method for transmitting electronic mail from a sender to a plurality of recipients is provided by use of a software application that allows a sender to designate a recipient as one of several categories. A first category is a primary recipient of the electronic mail and is to receive both a text message and an attached file. A second category is a secondary recipient of the electronic mail and is to receive both a text message and the attached file. A third category is a tertiary recipient of the electronic mail and is to receive a text message without the attached file.

### CROSS-REFERENCE TO RELATED APPLICATION

This application claims benefit of U.S. Provisional Application No. 60/216,787, filed Jul. 7, 2000, which is hereby incorporated by reference.

### BACKGROUND OF THE INVENTION

1. Field of the Invention

The present invention relates to apparatuses and methods for distribution of e-mail messages to intended recipients. Most preferably, this invention relates to apparatuses and methods for sending e-mail to multiple recipients, with one or more of the intended recipients receiving only a limited portion of the e-mail.

2. Related Background

E-mail messages have in recent years come to challenge the telephone and facsimile machine for the transmission of information from a sender to one or more recipients. People utilize e-mail programs to transmit information either over the Internet, a wide area network (WAN), metropolitan area network (MAN) or a local area network (LAN). In addition to business uses, people now use e-mail as a way to keep in touch with friends, even those living in far-flung places, without the necessity of postage and with nearly instant delivery. Further, with the development of “white pages” directories on the Internet, it has become much easier to look up a person's e-mail address even if you only know their name.

E-mail messages are sent in the same manner as most Internet data. That is, Transmission Control Protocol (TCP) breaks the message into packets, and the Internet Protocol (IP) delivers the packets to the proper location, and the TCP reassembles the message at the receiving end so that it can be read.

The basic format of the conventional e-mail message is ASCII text, a format that can be read by most computers. In addition to the basic ASCII text message that forms the base portion of an e-mail message, most recent e-mail programs allow one or more binary files, such as word processing files, graphic images, or even sound or video files, to be sent by “attaching” the file to the e-mail message. However, since the Internet is not able directly to handle non-ASCII binary files in e-mail, encoding methods have been developed to allow such files to be sent with e-mail. On example is Multipurpose Internet Mail Extensions (MIME), a specification for formatting non-ASCII messages so that they can be sent over the Internet. Another encoding technique is uuencode. A recipient of a message with such a coded attachment must decode the message using the same scheme used to encode the attachment.

Known e-mail programs permit a sender to transmit a message to multiple parties with only a single action, if the electronic addresses of all intended recipients have previously been entered. Further, most conventional e-mail programs include the option to designate several categories of recipients. For example, in the program Microsoft Outlook®, the user may designate a recipient as a “To” recipient, indicating that that recipient is an intended primary recipient of the e-mail transmission, or as a “cc” recipient, indicating that that recipient is not a primary recipient, but is to receive a copy of the e-mail transmission simply to keep them advised of the communication and its substance. Both “To” and “cc” recipients receive in their copy of the e-mail transmission an indication of the other “To” and “cc” recipients that have received that e-mail transmission as well.

Microsoft Outlook® (and other programs) also provide a third category of recipient, “bcc” (blind carbon copy) indicating that the recipient is to receive a copy of the e-mail transmission, but that other designated recipients will not be notified that the “bcc” recipient received the e-mail transmission.

As was discussed above, most conventional e-mail programs provide an editor in which the sender may compose the standard (ASCII) message, and further provide the sender with the ability to attach one or more electronic files as attachments. As discussed above, attachments are simply electronic files, which may be generated by other software applications, such as a text file generated with a word processing program; or an image file generated by scanning a photograph, or the like. In a typical e-mail transmission with attachment, the ASCII message composed using the e-mail editor comprises only a small fraction of the total size (as measured in bytes) of the e-mail transmission. The large bulk of the e-mail transmission is represented by the binary attachment or attachments.

One problem with current methods of transmitting e-mail attachments is that, because of the potentially significant size of such attachments, a large amount of network communications bandwidth can be consumed in order to transmit such attachments. Costly network resources may also be required as such message and attachments traverse several nodes or elements of the network on the way from the sender to the recipient node. Additionally, the memory storage devices of local nodes of the network that often store such incoming e-mail messages and their associated attached files may be overloaded by many incoming e-mail messages.

The increased traffic of e-mail transmissions has become a significant burden on the supporting communication infrastructure, including the servers used to send, receive and store e-mail transmissions as well as the physical transmission media (i.e. fiber optical cables, telephone lines, satellite systems, etc.) itself. The magnitude of the burden is amplified dramatically when e-mail transmissions include attachments, particularly large or multiple attachments such as large documents and/or image files. The problem is further exacerbated by the fact that as discussed above, e-mail programs allow users to very easily designate multiple recipients. When that is done, a separate copy of the e-mail transmission is generated for and sent to each designated recipient. This is true even when the sender really only needs the attachment to go to one or a few recipients, and simply wants the other recipients to be advised generally that the e-mail transmission has been sent.

While a sender can reduce the amount of traffic on a system by composing an e-mail transmission that includes the attachment and sending that transmission only to those recipients who the sender wants to receive the attachments, and then composing a separate e-mail transmission for those recipients who the sender wants to receive the message only, without the attachments, such an approach is cumbersome for the user in that it requires the sender to compose at least two separate e-mail transmissions. An additional disadvantage is that neither the recipients who receive the attachments nor the recipients who receive only the message receive a full list of recipients. This second disadvantage might be partially overcome by providing the main recipients with copies of the e-mail transmission sent to the secondary recipients, but this solution would require that the main recipients receive two e-mail transmissions instead of just one, inconveniencing those recipients and increasing communication system traffic.

An additional complication is that some recipients are unable to receive attachments for any of a number of reasons including but not limited to: transfer protocol incompatibility, size restrictions or firewall settings. When an e-mail transmission encounters one or more of these obstacles, it is “bounced” back to the sender or is lost with no notification. The disadvantage is that the rejection of the attachment also prevents the recipient from seeing the ASCII text portion of the message, which may have been all that was necessary for him to have received in the first place.

Moreover, there is a class of recipients of e-mail transmissions who conduct the majority of their electronic communications over public switched telephone system (PSTN) lines, instead of over broad band connections such as DSL, T1 and optical/cable modem. Such users are typified by business travelers who spend large amounts of their time in hotels, with access only to hotel-provided phone lines for their relatively slow speed modem. For these travelers, the growth of large (as measured in bytes) e-mail transmissions has created a serious problem when coupled with the slow transmission rates of telephone modems. Large attachments can take multiple hours to download, creating a logistical nightmare and high costs in receiving such e-mail.

All of the above stated problems of e-mail transmission are certain to be further exacerbated as e-mail traffic increases and the size of attached electronic files increases with the spread of multimedia and graphics capability.

U.S. Pat. No. 5,903,723 to Beck et al. describes a method for reducing the bandwidth required to send attachments in e-mail. In the patented system, instead of actually sending the attached file to recipients, an HTML page is sent with a hypertext link to a location, in proximity to the sender of the e-mail, storing the attachment. If and when the recipient desires to read the attachment, he or she can click on the link, triggering the generation of the URL of the location of the attachment, and download or otherwise read the attachment. While the Beck et al. system reduces the volume of e-mail on the Internet, it paints with a broad brush, forcing all recipients, even those who would like to see the attachment right away, to visit a remote web site and wait for the attachment to download.

Thus, there is a need for an e-mail program that can allow a user to more precisely specify the type of information that each of the intended recipients will receive, and thereby allow the sender to communicate all necessary information without unduly increasing network traffic and without forcing the recipient to visit a web site to download the attachment.

### SUMMARY OF THE INVENTION

The present invention addresses the above concerns and presents new and novel apparatuses and processes for an e-mail management system that allows a sender to earmark which recipients from a distribution list will receive an attached file.

In accordance with one aspect of the present invention, there is provided a software application for transmitting electronic mail from a sender to a plurality of recipients. The software application comprises: code for enabling the sender to input a message, code for enabling the sender to append an attachment to the message, code for enabling the sender to designate at least one recipient of the plurality of recipients to receive the message and the attachment, and code for enabling the sender to designate at least one recipient of the plurality of recipients to receive the message without the attachment.

In accordance with another aspect of the present invention, there is provided a software application for transmitting electronic mail from a sender to a plurality of recipients. The software application allows a sender to designate a recipient as one of the following categories: a first category indicating that the recipient is a primary recipient of the electronic mail and is to receive both a text message and an attached file; a second category indicating that the recipient is a secondary recipient of the electronic mail and is to receive both a text message and the attached file; and a third category indicating that the recipient is a tertiary recipient of the electronic mail and is to receive a text message without the attached file.

In accordance with another aspect of the present invention, there is provided an apparatus for transmitting electronic mail from a sender to a plurality of recipients. The apparatus comprises: means for enabling the sender to input a message; means for enabling the sender to append an attachment; means for enabling the sender to designate at least one recipient to receive the message and the attachment; and means for enabling the sender to designate at least one recipient to receive the message without the attachment.

In accordance with yet another aspect of the present invention, there is provided a method for transmitting electronic mail from a sender to a plurality of recipients. The method comprises: inputting a message; appending a attachment to the message; designating at least one recipient of the plurality of recipients to receive the message and the attachment; and designating at least one recipient of the plurality of recipients to receive the message without the attachment.

In accordance with still another aspect of the present invention, there is provided a program-controlled apparatus operable to communicate via e-mail with one or more recipient computers. The apparatus is operable to allow a user of the apparatus to: input a message; append a attachment to the message; designate at least one recipient of the plurality of recipients to receive the message and the attachment; and designate at least one recipient of the plurality of recipients to receive the message without the attachment.

### BRIEF DESCRIPTION OF THE DRAWINGS

FIG. 1 is a block diagram showing an e-mail system having the functionality of the present invention in a multi-networked environment;

FIG. 2 is a diagram showing software resident on the hard drive of computers shown in FIG. 1;

FIG. 3 is a blank graphical user interface for the e-mail program of the present invention;

FIG. 4 is a graphical user interface for the e-mail program of the present invention showing how recipients may be designated;

FIG. 5 is a list of received mail in accordance with the e-mail program of the present invention;

FIG. 6 is a list of intended recipients that provides a check box to designate whether or not the listed recipient is to receive attachments;

FIG. 7 is a flow diagram illustrating the process of generating an e-mail recipient list in accordance with a preferred embodiment of the present invention; and

FIG. 8 is a flow diagram illustrating the process of dividing the recipient list in accordance with whether the recipients are to receive an attached file or files.

### DETAILED DESCRIPTION OF THE PREFERRED EMBODIMENT

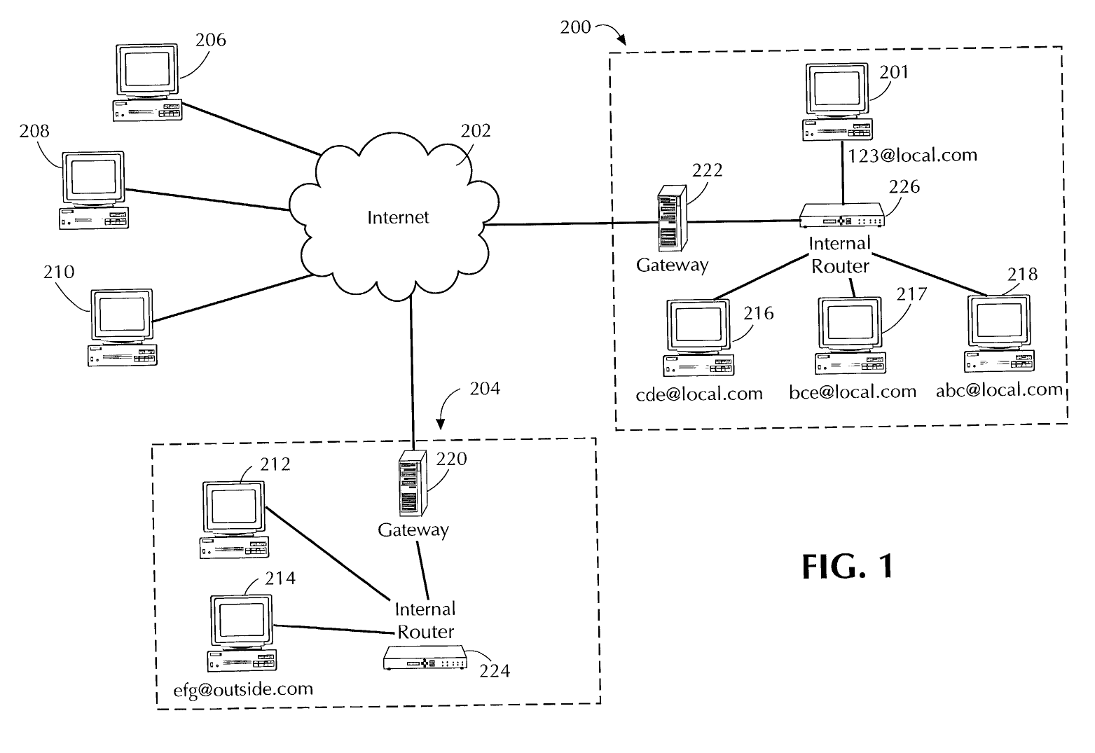

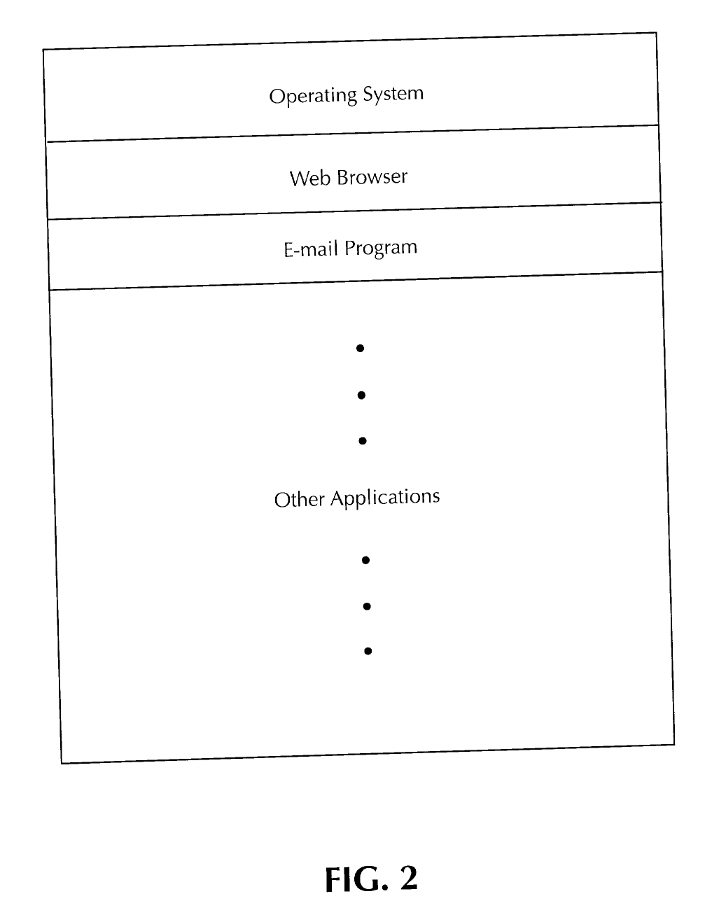

FIGS. 1-8 illustrate preferred embodiments of the split-distribution e-mail apparatus and method according to the present invention.

FIG. 1 illustrates various blocks of the e-mail system of the present invention and graphically shows how those blocks interact in operation. Sender computer 201 includes on its hard drive the e-mail program of the present invention. All potential recipient computers illustrated include an e-mail program as well. However, those programs may or may not be in accordance with present invention. That is, it is not necessary for the recipient programs to be in accordance with the present invention for the sender to take advantage of the features engendered by the invention.

As shown in the figure, LAN 200 has sender computer 201, gateway 222, internal router 226 and potential recipient computers 216, 217 and 218. The LAN 200 is in communication with the Internet 202 by means of the gateway 222. Other potential recipient computers 212 and 214 are shown as being within LAN 204, which includes gateway 220 and internal router 224. Potential recipient computers 206, 208 and 210 are connected directly to the Internet 202.

In the figure, the sender computer 201 is shown as being connected to a local area network (LAN) 200. However, this need not be the case, as the sender can be connected directly to the Internet 202. Alternately, as will be appreciated, the present invention also has utility for a LAN only system without the involvement of the Internet 202.

The manner in which e-mail moves within and among networks will now be described with reference to FIG. 1. Sender computer 201 is a node in LAN 200 and may send e-mail within the LAN as well as to e-mail addresses outside of the LAN. In a first example, the sender computer 201, which has an address of 123@local.com, sends an e-mail message to abc@local.com, an internet address of computer 218 within the sender's LAN 200. The mail first is broken up into Internet TCP/IP packets and those packets go initially to internal router 226. Internal router 226 examines the address and determines that the address is within the LAN. The router therefore routes the message internally to computer 218, which has the recipient address abc@local.com.

A second message sent, in the example, from sender computer 201 is addressed to efg@outside.com. This message is recognized by the internal router as being addressed to someone outside the LAN 200, and is routed to the Internet. Before being sent over the Internet, the message passes through gateway 222, which may include a firewall, which keeps track of data going out onto the Internet and may selectively prevent certain types of messages from being so transmitted.

Once the message is on the Internet 202, it is transmitted to an Internet router (not shown). The Internet router examines the address and directs the message to the destination. The receiving network, in this case LAN 204, receives the incoming message through a gateway 220, which uses TCP to reconstruct the message from its constituent packets, and translates the incoming message into a format that can be used by the receiving network. Of course, the receiving network may also include one or more firewalls to protect the network. Once received by the receiving network, an internal router 224 directs the message to the computer 214 to which the message is addressed.

The e-mail program of the present invention provides functionality to present the user with the same options for sending e-mail messages as in prior art programs, but with the additional functionality to allow the user to designate which recipients from among “to”, “cc” and “bcc” fields should receive attached files. By offering the sender this option, and the other advantageous options detailed below, the present invention allows attachments, which are usually very much larger than the basic text message, to go only to those recipients who really need to see them, while at the same time allowing the main (ASCII) text of the message to go to all recipients.

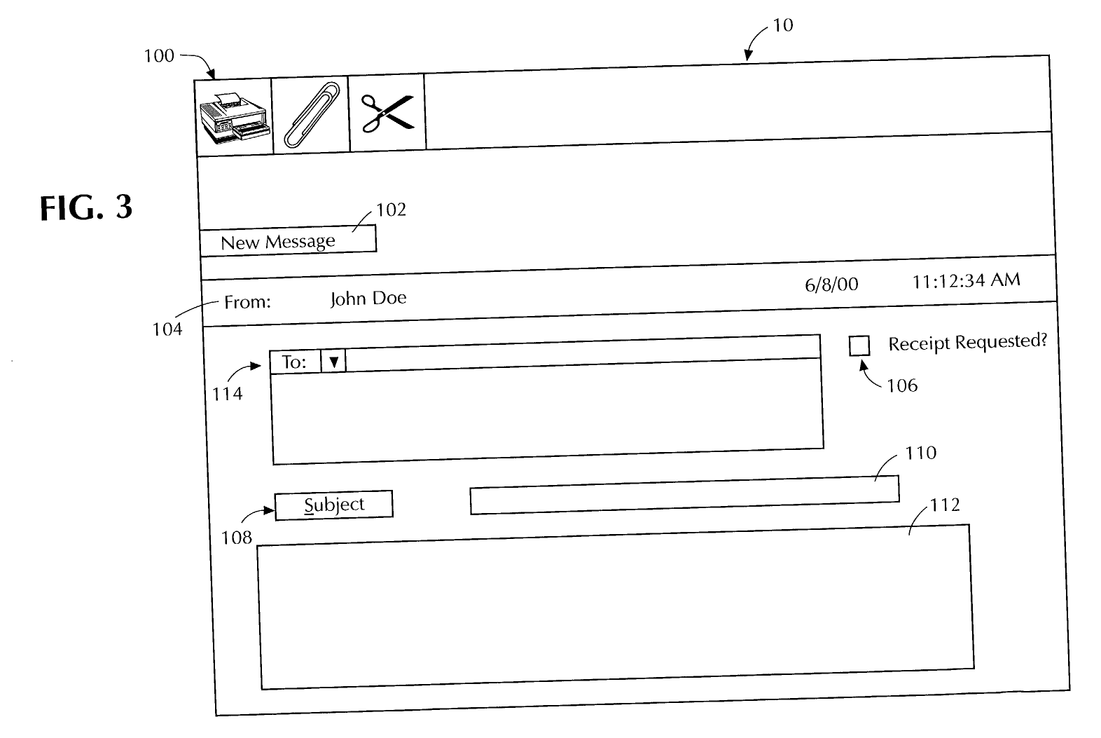

The program of the present invention generates and displays, by well-known software methods, a graphical user interface to the user of a computer on which the program is resident and running. A preferred example of such a user interface is shown in FIG. 3. In the figure, graphical user interface (GUI) 10 presents the user with a suite of functions allowing him or her to set up and send an e-mail message to one or more recipients. A toolbar 100 is provided along the top of the GUI 10 to allow the user to select certain options and/or shortcuts to options by clicking on representative icons with a mouse or other similar selecting or pointing device. Among the functions preferably provided in the toolbar are the ability to print, shown by the printer icon, attach a file, shown by the paper clip icon, and cut, shown by the scissors icon.

To initiate a new message session, the user clicks the new message button 102. This has the effect of presenting a cleared GUI 10 screen allowing recipient and other information to be entered. User “from” bar 104 automatically displays the name of the person whose computer is running the software, such information having been entered at set up in a conventional manner. While convenient, the provision of the “from” bar is in no way necessary and does not form a part of the invention. In addition to the name of the sender, the date and time of composition of the message is preferably displayed in the “from” bar.

Radio button 106 allows the user to indicate that he or she would like a return receipt once the recipient of each message has received the message. Subject button 108, once selected, moves the text cursor to the subject field 110, at which the subject of the message can be entered. Text entry field 112 is where the user will type the ASCII portion of the message. If attachments are included in the message, an icon will preferably be shown in this field below the ASCII text message.

To send an attachment with the message, the user clicks the paper clip icon from the toolbar 100 and is presented with a menu representative of the operating system environment, allowing one or more files to be perused and selected for attachment from the network, the user's hard drive, the user's floppy disk, or even a file located on the Internet. Once the file or files have been selected for attachment, an icon representative of the file type is preferably displayed in the text entry field 112. The process of adding attachments to the message may be repeated iteratively, until all the desired files have been attached.

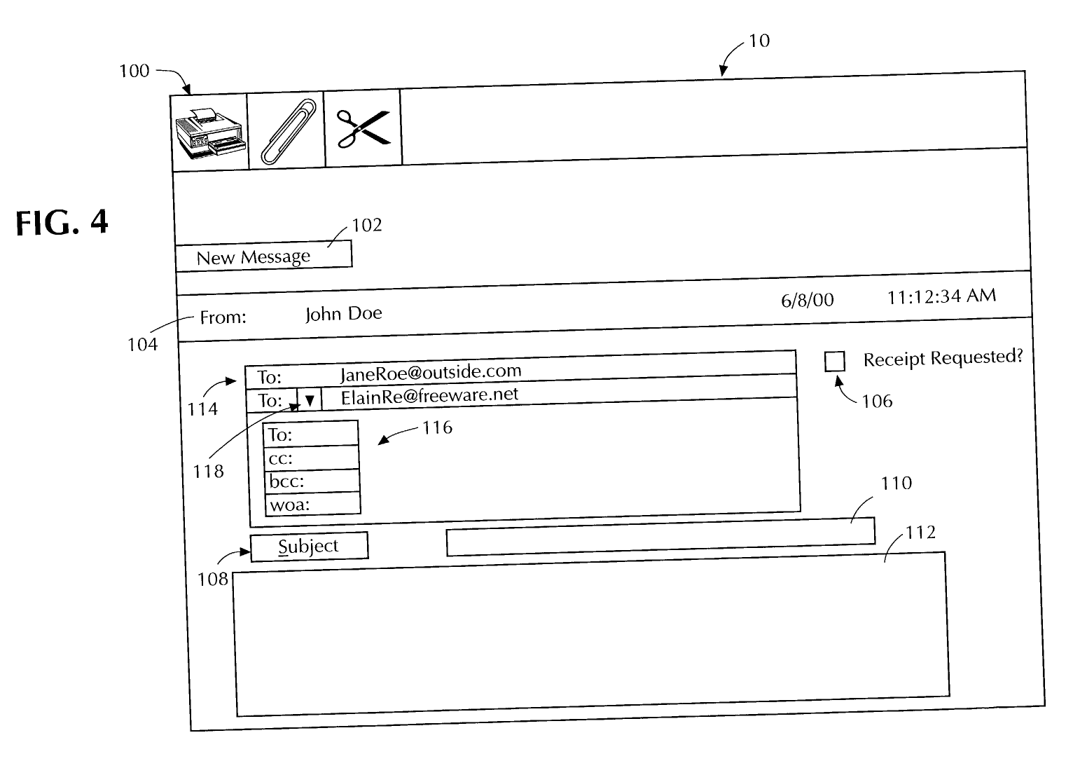

The recipient or recipients of the message are entered in recipient area 114, to be described in more detail below. Selection of recipients of the e-mail message is described with reference to FIG. 4. As shown in the figure, an initial recipient is typed in the first available location in recipient area 114. The default setting for each recipient is to be designated as a “to” recipient. Therefore, the indication “to” will appear unless it is changed. Generally, a recipient to whom the message is “to”, may be expected to take some action in response to the action. After the e-mail address of the first recipient has been typed, and the sender is satisfied as to the recipient's “to” designation, the user may press the enter key and a second line is presented for entry of another recipient.

The user may wish to designate, for example, second and subsequent recipients of the message as carbon copy “cc” or blind carbon copy “bcc”, as describe above. This is preferably achieved by allowing, for each entered recipient, a drop down menu 116 to be displayed in response to clicking of button 118. As can be seen from the figure, the drop down-menu allows the recipient at whose line the menu is selected to be designated as “to”, “cc” or “bcc”. In addition to selecting one of the above designations for each recipient, the program of the present invention advantageously allows a designation without attachment “woa” to be selected. If the user selects “woa” in conjunction with one of the other designation, then that person will receive only the ASCII portion of the message, but will not receive the attached file.

While the illustrated embodiment shows designation of “to”, “cc”, “bcc” taking place in the same field, the present invention is not limited to such an embodiment. The present invention would be equally applicable to e-mail programs that have separate fields for these designations.

While each recipient can be individually selected to customize who gets the attachments for every e-mail, the program of the present invention preferably maintains a default mode with regard to who receives attachments. In a particularly preferred implementation, the default mode will be set such that all recipients designated as “to” recipients receive the attachment, while those designated as “cc” and “bcc” do not, setting that are subject to change by positive action of the user.

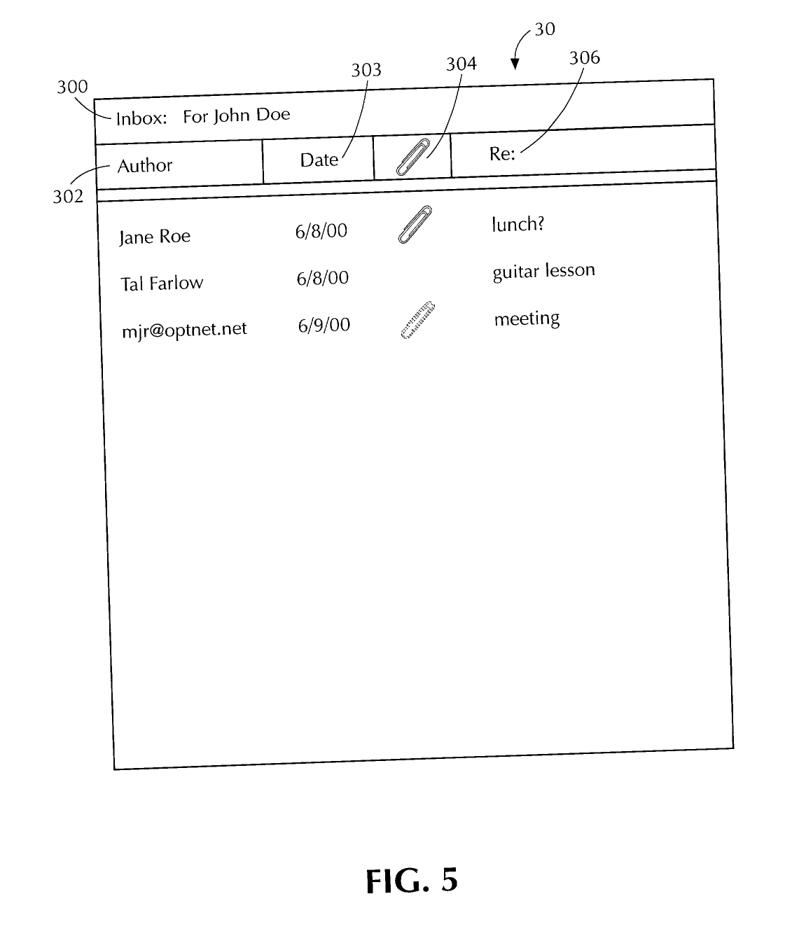

FIG. 5 shows a preferred implementation of how the e-mail program of the present invention displays received e-mail, especially with regard to how the attachments in the received message are indicated. As can be seen from the figure, inbox GUI 30 preferably includes field 300, which includes an indication of the name of the recipient of the mail in the inbox. Author field indicator 302 indicates the column that displays the author of the received mail. Date field indicator 303 indicates the column that indicates the date of the received mail. Paper clip icon 304 indicates the column that shows whether or not a file has been attached to the message. In a preferred embodiment, this field can have one of three values: 1) no icon, where no attachment forms a part of the message; 2) the paper clip icon, to indicate received mail that includes an attached file; and 3) a ghosted icon, which indicates that an attachment to the message has been left out in the recipients version of the message. Such an indication advantageously makes the recipient aware that an attachment was part of the complete message and the recipient has the opportunity to request to be sent the complete message, if the recipient desires the attachment, by, for example, replying to the message and requesting that he be sent the message with the attachment.

While the preferred embodiment of the e-mail program discussed above has a default setting allowing “to” recipients to get attachments while withholding the attachments from cc and bcc recipients, the invention may be implemented with many different available options. For example, in one advantageous variation, the program may default as described previously, while allowing general program-wide options to be made available to the user to enable attachments to be sent to cc and/or bcc as well.

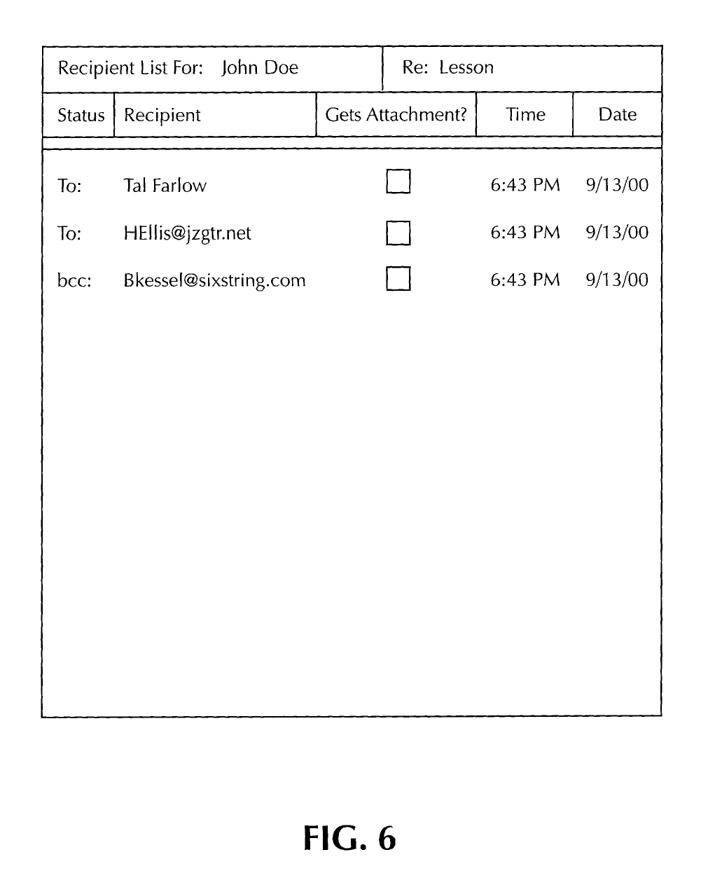

Another variation is to present the user with a list of all (To, cc, bcc) recipients and boxes to check and indicate which of those recipients, if any, get the attachments. An example of such a list is shown in FIG. 6. A further variation to the list implements the default in favor of “to” recipients by having their boxes already checked when the screen of FIG. 6 is displayed. However, the default selection is subject to override by the user.

In another preferred embodiment, the program also advantageously provides a mode in which first time recipients receive attachments, unless specifically selected so as not to, and previous recipients are set the same way they were set for the last message sent to those recipients.

While the above implementations have been described in terms of on-the-fly message formatting, the above default modalities may be implemented in accordance with determinations made by the user in an e-mail address book—the setting being changeable for a particular message without altering the default.

In some situations, certain recipients simply cannot accept certain messages. In such a situation, the program of the present invention advantageously provides for an absolute block to be set in relation to users who have a known restriction on permitted attachments size. For example, many company firewalls restrict e-mail transmissions to a certain size (such as 2 megabytes)—the program of the present invention then designates users on that system so as never to be sent a file whose attachments exceed the specified size, in combination with any other default setting for files smaller than the threshold set forth above.

In another preferred implementation, the default setting is that no one gets attachments. While many of the above preferred implementation utilize default options, it will be appreciated that the invention is not limited in this regard.

Further, the invention may be implemented on an attachment by attachment basis, rather than grouping all attachments together. For example, in another preferred embodiment, in messages with multiple attachments, the sender can designate that some but not others of the attachments be sent to a particular recipient.

At the recipient side, potential recipients preferably can select from reception options with regard to receipt of attachments to form a reception profile. For example, users of the e-mail system can specify that they cannot receive attachments larger than a particular size. Preferably, other options can be selected. The program preferably can be set such that certain dates will be blacked out with regard to reception of attachments. For example, if the recipient will be out of town for a two week period, he or she can select to accept no attachments during that period, or no attachments except for those sent from a particular sender or senders.

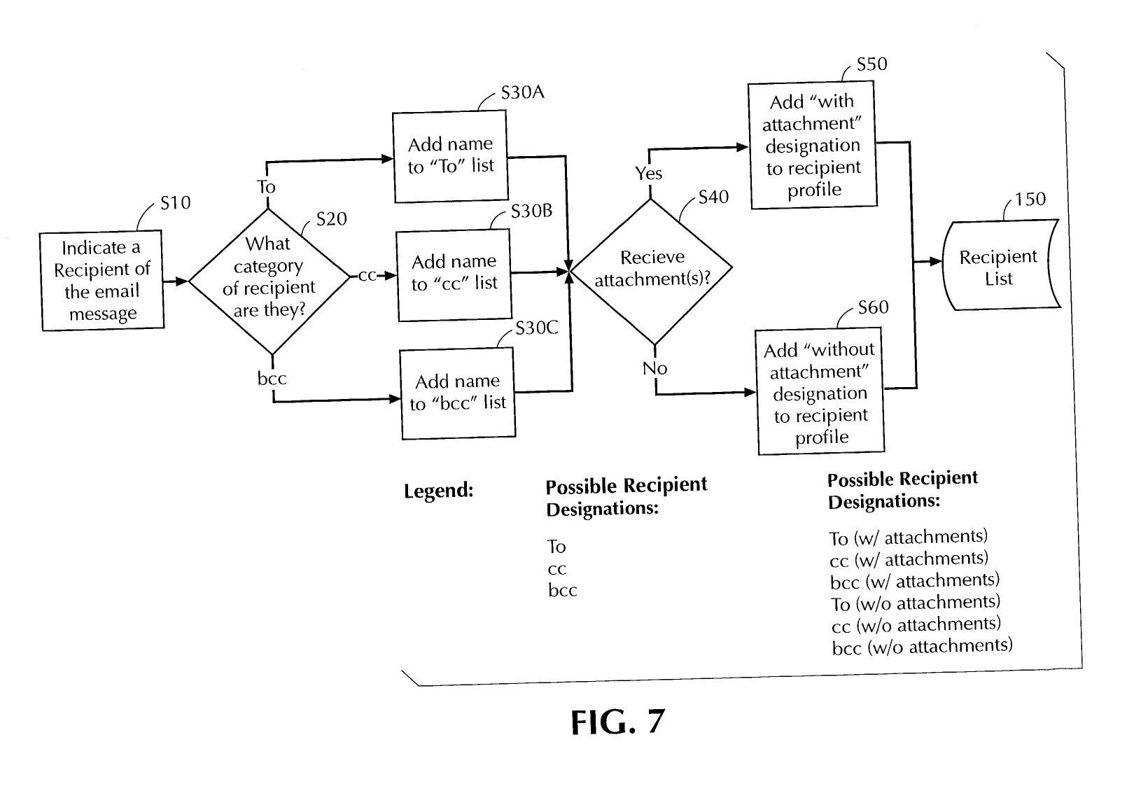

FIG. 7 is a flow diagram illustrating a process for generating an e-mail recipient list in accordance with a preferred embodiment of the present invention. As shown in the figure, in step S10, a recipient of the e-mail message is indicated, typically by the sender of the e-mail. At step S20, if the category of the recipient is designated as being a “To” recipient, the process flow proceeds to step S30A, at which the so-designated recipient is added to the “To” list. If the recipient is designated as being a “cc” recipient, the process flow proceeds instead to step S30B, at which the so-designated recipient is added to the “cc” list. If the recipient is designated as being a “bcc” recipient, the process flow proceeds instead to step S30C, at which the so-designated recipient is added to the “bcc” list. In any of the above cases, the process flow next proceeds to step S40 at which it is determined whether the recipient currently being designated is to receive an attachment or attachments. If the answer is yes, the flow proceeds to step S50, at which “with attachment” is added to the recipient's profile. If the answer at step S40 is no, the flow proceeds to step S60, at which “without attachment” is added to the recipient's profile. Recipient list 150 is generated from the above steps.

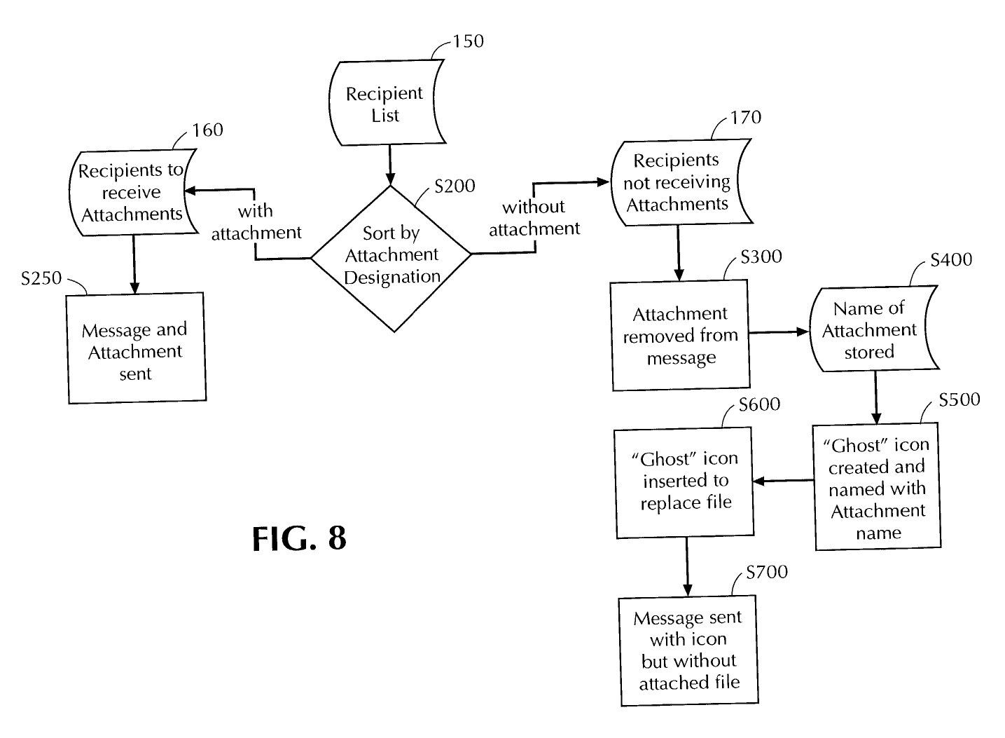

FIG. 8 shows the process by which the recipient list is processed to enable split distribution of attachments in accordance with a preferred embodiment of the present invention. As shown in the figure, recipient list 150 is examined at step S200 and sorted by attachment designation. The recipients that have been designated as “with attachment” are added to recipients to receive attachments 160 and at step S250 the message and attachment or attachments are sent. Those recipients that have been designated as “without attachment” are added to recipients not receiving attachments 170 and at step S300 have the attachment removed from the message. Next, at step S400, the name of the attachment is stored, at step S500 a ghost icon is created and named for the name of the attachment that will not be sent, and, at step S600, the ghost icon is inserted into the message to replace the file. Next, at step S700, the message is sent with the icon but without the attached file.

The above exemplary embodiments have been described in terms an e-mail program that supplies a GUI. However, the technique of the present invention is not limited to such interface techniques. For example, the present invention can be implemented using a DOS command based system or a voice activated system.

As will be appreciated, the program of the present invention can be part of a larger mail program or can exist as an add on program to run with existing mail programs, using known software upgrading techniques.

Other variations and modifications of this invention will be apparent to those skilled in this art after careful study of this application. This invention is not to be limited except as set forth in the following claims.

What is claimed is:

1. A software application for transmitting electronic mail from a sender to a plurality of recipients, comprising:
code for enabling the sender to input a message;
code for enabling the sender to append an attachment to the message;
code for enabling the sender to designate at least one recipient of the plurality of recipients to receive the message and the attachment; and
code for enabling the sender to designate at least one recipient of the plurality of recipients to receive the message without the attachment.

2. A software application according to claim 1, wherein the sender and the recipients are computers connected to a network.

3. A software application according to claim 2, wherein the network is the Internet.

4. A software application according to claim 2, wherein the network is a local area network (LAN).

5. A software application according to claim 2, wherein the network is a wide area network (WAN).

6. A software application according to claim 1, further comprising:
code for enabling the recipient to create and edit a recipient profile, the profile including the recipient's preferences with regard to receipt of attachments.

7. A software application for transmitting electronic mail from a sender to a plurality of recipients, said software application allowing a sender to designate a recipient as one of the following categories:
a first category indicating that the recipient is a primary recipient of the electronic mail and is to receive both a text message and an attached file;
a second category indicating that the recipient is a secondary recipient of the electronic mail and is to receive both a text message and the attached file; and
a third category indicating that the recipient is a tertiary recipient of the electronic mail and is to receive a text message without the attached file.

8. A software application according to claim 7, wherein the sender and the recipients are computers connected to a network.

9. A software application according to claim 8, wherein the network is the Internet.

10. A software application according to claim 8, wherein the network is a local area network (LAN).

11. A software application according to claim 8, wherein the network is wide area network (WAN).

12. An apparatus for transmitting electronic mail from a sender to a plurality of recipients, comprising:
means for enabling the sender to input a message;
means for enabling the sender to append an attachment;
means for enabling the sender to designate at least one recipient to receive the message and the attachment; and
means for enabling the sender to designate at least one recipient to receive the message without the attachment.

13. An apparatus according to claim 12, wherein the sender and the recipients are computers connected to a network.

14. An apparatus according to claim 13, wherein the network is the Internet.

15. An apparatus according to claim 13, wherein the network is a local area network (LAN).

16. An apparatus according to claim 13, wherein the network is wide area network (WAN).

17. An apparatus according to claim 12, further comprising means for enabling the recipient to create and edit a recipient profile, the profile including the recipient's preferences with regard to receipt of attachments.

18. A method for transmitting electronic mail from a sender to a plurality of recipients, comprising:
inputting a message;
appending an attachment to the message;
designating at least one recipient of the plurality of recipients to receive the message and the attachment; and
designating at least one recipient of the plurality of recipients to receive the message without the attachment.

19. A method according to claim 18, wherein the sender and the recipients are computers connected to a network.

20. A method according to claim 19, wherein the network is the Internet.

21. A method according to claim 19, wherein the network is a local area network (LAN).

22. A method according to claim 19, wherein the network is wide area network (WAN).

23. A method according to claim 18, further comprising enabling the recipient to create and edit a recipient profile, the profile including the recipient's preferences with regard to receipt of attachments.

24. A program-controlled apparatus operable to communicate via e-mail with one or more recipient computers, the apparatus being operable to allow a user of the apparatus to:
input a message;
append a attachment to the message;
designate at least one recipient of the plurality of recipients to receive the message and the attachment; and
designate at least one recipient of the plurality of recipients to receive the message without the attachment.

25. An apparatus according to claim 24, wherein the apparatus and the recipients are computers connected to a network.

26. An apparatus according to claim 25, wherein the network is the Internet.

27. An apparatus according to claim 25, wherein the network is a local area network (LAN).

28. An apparatus according to claim 25, wherein the network is wide area network (WAN).

29. An apparatus according to claim 24, the apparatus further being operable to enable the recipient to create and edit a recipient profile, the profile including the recipient's preferences with regard to receipt of attachments.
